(19) United States
(12) Patent Application Publication
(10) Pub. No.: US 2019/0100124 A1
(43) Pub. Date: Apr. 4, 2019

(54) Active Seat Car Seat Massager

(71) Applicant: Scott Alexander, Chicago, IL (US)

(72) Inventor: Scott Alexander, Chicago, IL (US)

(21) Appl. No.: 16/152,390

(22) Filed: Oct. 4, 2018

Related U.S. Application Data
(60) Provisional application No. 62/568,140, filed on Oct. 4, 2017.

(51) Int. Cl. B60N 2/90

(52) U.S. Cl. CPC B60N 2/976; A61H 9/0078

(57) ABSTRACT

A car seat massager comprising a series of individual, internal inflatable bubbles capable of being inflated and deflated in a specific pattern of inflation and deflation by means of a compressor and vacuum pump, respectively.

### CLAIM OF PRIORITY

This patent application claims priority under 35 USC 119 (e) (1) from U.S. Provisional Patent Application Ser. No. 62/568,140, filed Oct. 4, 2017, of common inventorship herewith entitled, “CAR SEAT MASSAGER,” which is incorporated herein by reference as though the same were set forth in its entirety.

### FIELD OF THE INVENTION

The present invention pertains to the field of motorist accessories, and more specifically to the field of therapeutic car seats.

### BACKGROUND OF THE INVENTION

The prior art has put forth several designs for therapeutic car seats. Among these are:

US Patent Publication 2012/0032478 to Sven Friderich, Gerhard Hauser. Werner Schiele, Gudrun Weiser and Ulrich Woerner describes a vehicle seat that includes a pad of a seat cushion and of a backrest. A massage device has a plurality of pressurizable elements integrate into the pad to influence the contour of the seat and each of which is controlled separately. A control device controls the massage device and also a seat climate control system.

U.S. Pat. No. 7,311,681 to Christalla Vaccarella describes a motor vehicle seat having massage units positioned therein and controllable by each user including neck, back and seat. Each massage unit is comprised of a housing having rotational and vibratory members therein that when energized extend beyond the housing in an operative position. When powered off, the rotational and vibratory members retract into the housing.

U.S. Pat. No. 5,029,939 to Jack E. Smith and John F. Hoying describes a vehicle seat construction and method of utilization of the same. An inventive vehicle seat construction alternately supports a vehicle seat occupant upon different portions of the vehicle occupant's body. The above massaging effect relieves the vehicle seat occupant of possible discomfort realized after extended driving periods. Additionally, the inventive seat structure provides the alternating support feature while allowing the vehicle seat to function normally in the absence of the power to the pneumatic system which energizes the alternating support feature.

None of these prior art references describe the present invention.

### SUMMARY OF THE INVENTION

It is an object of the present invention to provide a therapeutic car seat cushion massager specifically constructed to utilize shifting support for the muscles of the buttocks.

### BRIEF DESCRIPTION OF THE DRAWINGS

FIG. 1 is a front perspective view of the present invention showing a car seat cushion massager having internal bubbles which inflate and deflate in various patterns.

FIG. 2 is a front perspective close-up view of the present invention showing internal bubbles which inflate and deflate in various patterns.

FIG. 3 is an illustrative diagrammatic view of the present invention showing a vacuum component and a compressor component which are integrally wired through the bubble cells of the car seat cushion and alternate in operation to inflate and deflate the bubble cells after the car seat massager is switched on.

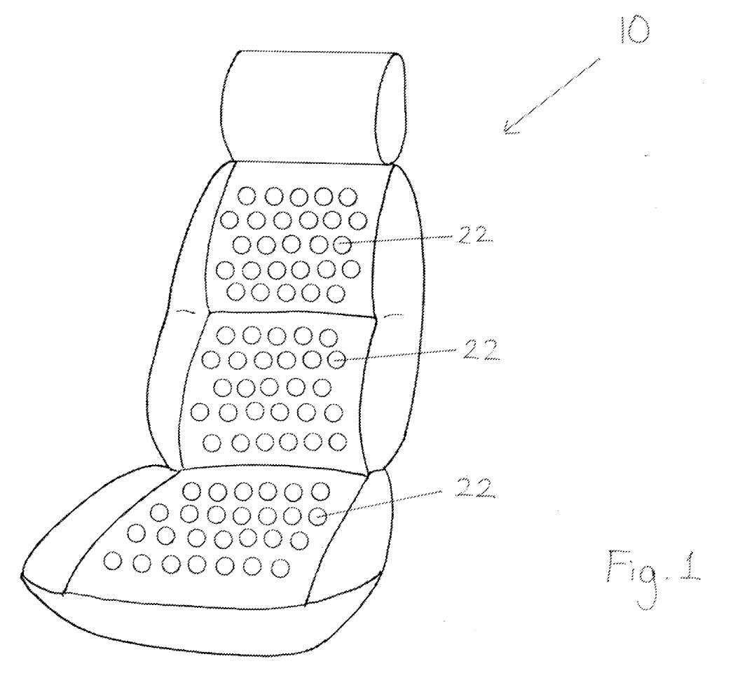

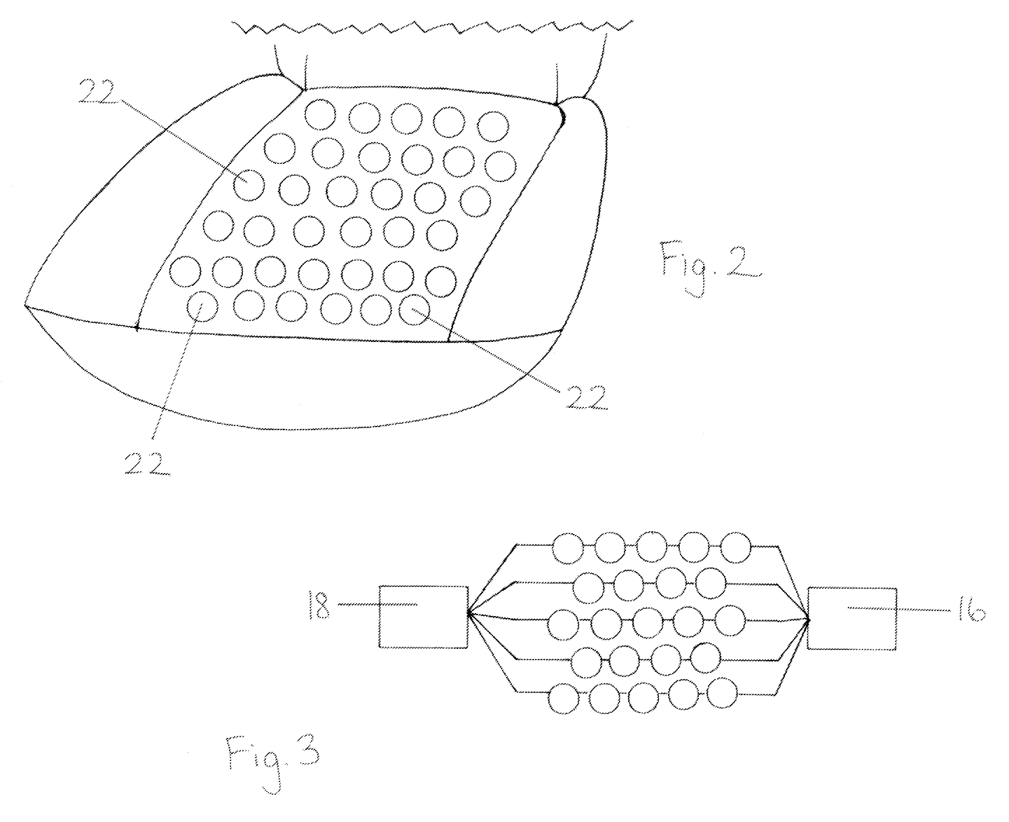

### DETAILED DESCRIPTION OF THE INVENTION

With continued sprawl of urbanization and increasing preference of the automobile as mode of travel, many people are spending more and more time behind the wheel of a vehicle. An average commuter spends approximately ninety three minutes a day in a vehicle, which is equivalent to almost two weeks annually. Factoring in driving children to school and recreational activities along with trips to the market for supplies and spontaneous weekend road adventures, these numbers expand much more Automobiles are essential in daily lives, but driving often brings unique brands of stress such as a traffic accident turning a freeway into a veritable parking lot, road construction closing off a speedy shortcut or weather conditions rendering dangerous maneuvering. The trip to work or school sometimes becomes a daunting and challenging journey.

Along with mental tension that driving fosters, prolonged periods behind the wheel result in physical stress as well. Particularly, sitting in the driver's position can wreak havoc on one's buttocks as well as their lower back area. Unable to comfortably position oneself while concentrating on the road, a driver may experience fatigue, soreness and poor circulation from such a prolonged period of inactivity. Driving can lead to recurring problems such as sciatica and lower back pain, limiting one's ability to complete even simple daily tasks.

Please refer to the drawings. The present invention, hereinafter referred to as the Active Seat Car Seat Massager, or simply Active Seat, is a car seat cushion providing massage capabilities specifically constructed to utilize shifting support for the muscles of the buttocks. The Active Seat provides those who must sit in vehicles for extended periods with a simple and effective means of alleviating strain and fatigue in their buttocks area.

The Active Seat 10 utilizes a series of individual, internal inflatable bubbles 22 which inflate and deflate in various patterns. These bubbles 22 function in shifting support for the muscles of the buttocks, back, and legs, and alternating pressure points. The present invention provides motorists who sit in vehicles for extended periods with a simple and effective means of alleviating strain and fatigue in aforementioned body areas.

The bubbles 22 are inflated by means of compressor 16 and deflated by means of vacuum pump 18. Compressor 16 and vacuum pump 18 are in fluid communication with bubbles 22 by means of tubing.

In an embodiment, bubbles 22 can be fluidly connected in groups to permit specific patterns of inflation and deflation. In an alternative embodiment, bubbles 22 can be arranged and fluidly connected in a continuous series. In a further alternative embodiment, bubbles 22 can be or arranged in series communication. In an embodiment, bubbles 22 can be arranged to allow an alternating pattern of inflation and deflation, or in any desired pattern.

The Active Seat also comprises a controller for selecting the desired pattern of inflation and deflation according to the needs of the user. Suitable controller devices are knownin the art. For example, such devices can be found in U.S. Pat. Nos. 3,613,671; 8,827,371; and JP 2003265571, for example.

Relatively simple in configuration yet extremely effective in application, the Active Seat 10 need only be placed onto a car seat and sat upon to immediately begin providing soothing relief to different pressure points found on this area of the body. Using the Active Seat alleviates driver fatigue, helping to keep the buttocks as well as back and leg muscles from becoming painfully constricted while behind the wheel. The Active Seat prevents an onset of continuing problems in these areas as circulation in improved. Readily enhancing any commute by rotating pressure points to hit all affected muscles, the present invention permits users to sit comfortably for far longer periods of time. Durably constructed of high quality materials and components, the Active Seat will withstand many years of continued use. Suitable materials comprise thermoplastic materials such as polyethylene, polypropylene, or other thermoplastic or sheet material. The surface of the thermoplastic or sheet material can be textured or otherwise treated as desired, for comfort of the user.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A car seat massager comprising:
a series of individual, internal inflatable bubbles wherein the bubbles are capable of being inflated and deflated in a specific pattern of inflation and deflation, wherein the bubbles are inflated by means of a compressor and deflated by means of vacuum pump, wherein the compressor and vacuum pump are in fluid communication with the bubbles by means of tubing.

2. The car seat massager of claim 1, wherein the bubbles are fluidly connected in groups to permit specific patterns of inflation and deflation.

3. The car seat massager of claim 1, wherein the bubbles are fluidly connected and arranged in a continuous series.

4. The car seat massager of claim 1, wherein the cushion is made of a thermoplastic material such as polyethylene, polypropylene, or other thermoplastic or sheet material.

5. The car seat massager of claim 4, wherein the surface of the thermoplastic or sheet material can be textured or otherwise treated.

6. The car seat cushion massager of claim 1, further comprising a controller for selecting the desired pattern of inflation and deflation according to the needs of the user.

7. The car seat cushion massager of claim 1 wherein the pattern of inflation and deflation is selected to provide pressure to different pressure points found on the back and buttocks and back of legs areas of the body.
